(19) United States
(12) Patent Application Publication
(10) Pub. No.: US 2024/0205984 A1
(43) Pub. Date: Jun. 20, 2024

(54) METHOD AND APPARATUS FOR PROCESSING TRANSMISSION CONTROL PROTOCOL PACKET IN WIRELESS COMMUNICATION SYSTEM

(71) Applicant: ELECTRONICS AND TELECOMMUNICATIONS RESEARCH INSTITUTE, Daejeon (KR)

(72) Inventors: Myung San BAE, Daejeon (KR); Jae Wook SHIN, Daejeon (KR)

(73) Assignee: ELECTRONICS AND TELECOMMUNICATIONS RESEARCH INSTITUTE, Daejeon (KR)

(21) Appl. No.: 18/530,948

(22) Filed: Dec. 6, 2023

(30) Foreign Application Priority Data
Dec. 6, 2022 (KR) 10-2022-0169072

(51) Int. Cl. H04W 76/10; H04L 5/00; H04W 8/22; H04W 80/06

(52) U.S. Cl. CPC H04W 76/10; H04L 5/0053; H04W 8/22; H04W 80/06

(57) ABSTRACT

A method of a packet data convergence protocol (PDCP) in a terminal according to an exemplary embodiment of the present disclosure may comprise: receiving a connection request TCP packet from a TCP client of the terminal; transmitting the connection request TCP packet to a base station; creating an initial PDCP TCP context to perform at least part of a TCP procedure in advance; and transmitting the initial PDCP TCP context to a PDCP of the base station.

### CROSS-REFERENCE TO RELATED APPLICATIONS

This application claims priority to Korean Patent Application No. 10-2022-0169072, filed on Dec. 6, 2022, with the Korean Intellectual Property Office (KIPO), the entire contents of which are hereby incorporated by reference.

### BACKGROUND

### 1. Technical Field

Exemplary embodiments of the present disclosure relate to a packet transmission technique in a wireless communication system, and more specifically, to a transmission control protocol (TCP) packet transmission technique.

### 2. Related Art

Currently, a base station of the 3GPP system may comprise a media access control (MAC) layer, a radio link control (RLC) layer, a packet data convergence protocol (PDCP) layer, and a service data adaptation protocol (SDAP) layer to process data. The MAC layer controls media, the RLC layer controls radio links, the PDCP layer processes packet-level data, and the SDAP layer performs Quality of Service (QOS) management.

In case of downlink data in the 3GPP system, when the base station receives an Internet protocol (IP) packet, which is data to be transmitted from the network to a terminal, the SDAP layer receives it and may determine a QoS therefor. The PDCP layer of the base station may receive the packet, the RLC layer of the base station may transmit the data to the MAC layer, and then a physical layer of the base station may wirelessly transmit the data to the terminal. A physical layer of the terminal may wirelessly receive the data, and deliver the data to a MAC layer of the terminal, the MAC layer delivers it to an RLC layer of the terminal, the RLC layer delivers it to a PDCP layer of the terminal, and the PDCP layer delivers it to a SDAP layer of the terminal. Through this, the terminal can receive the IP data.

In case of uplink data in the 3GPP system, the SDAP layer of the terminal determines a QoS of IP data and delivers it to the PDCP layer. The PDCP layer processes the data in a packet unit and delivers it to the RLC layer. The RLC layer performs controls on a radio link and delivers the data to the MAC layer, and then the data may be transmitted by the physical layer to the base station through allocated radio resources. In response, the base station may deliver the IP data to a specific server through a delivery procedure in which the IP data is transmitted via the physical layer, MAC layer, RLC layer, PDCP layer, and SDAP layer. This data delivery procedure applies equally to all data.

When the 3GPP transitions to packet communication, and all applications perform IP-based packet communication, various protocols such as TCP, UDP, SCTP, ESP may be used at a transport layer. Among these, the most widely used transport layer protocol is Transmission Control Protocol (TCP).

However, TCP is a protocol designed for wired structures, and it requires a certain level of latency and appropriate delay to function reliably. For instance, when TCP packets with varying latencies coexist, TCP tends to maintain its speed according to the smallest latency, and a notable drawback occurs when the latency is relatively high, causing a significant slowdown as compare to a physical speed.

The current LTE/NR experiences a significant number of TCP retransmission packets even with a latency of 10 to 50 ms. In particular, satellite communication, which is to be used for next-generation communication, faces the challenge of not being able to achieve higher speeds despite securing high physical communication speeds when using TCP, due to the considerable physical distance involved.

To provide appropriate communication services over long-latency connections, alternatives such as using UDP instead of TCP, employing a separate proxy server, or using an additional stack to handle TCP/IP packets instead of relying on a system-provided TCP/IP may be necessary, resulting in inconveniences.

### SUMMARY

Exemplary embodiments of the present disclosure are directed to providing a method and an apparatus for PDCP layers to generate and deliver packets, in which the PDCP layers are designed to recognize TCP packets and operate them appropriately within a mobile communication system, so that the mobile communication system can effectively utilize the TCP packets.

According to a first exemplary embodiment of the present disclosure, a processing method in a PDCP of a terminal may comprise: receiving a connection request TCP packet from a TCP client of the terminal; transmitting the connection request TCP packet to a base station; creating an initial PDCP TCP context to perform at least part of a TCP procedure in advance; transmitting the initial PDCP TCP context to the base station; receiving a connection permission TCP packet from a TCP server through the base station; delivering the connection permission TCP packet to the TCP client; receiving a response to the initial PDCP TCP context from the base station; and in response to receiving a connection establishment TCP packet from the TCP client, discarding the received connection establishment TCP packet.

The processing method may further comprise: obtaining information on a size of a reception buffer of the TCP server included in the connection permission TCP packet.

The processing method may further comprise: receiving, from the TCP client, data TCP packet(s) including data to be transmitted to the TCP server; obtaining information on a size of the data included in the data TCP packet(s); transmitting the data TCP packet(s) to the base station; generating an acknowledgment TCP packet corresponding to the data TCP packet(s) transmitted to the base station; and transmitting the acknowledgment TCP packet to the TCP client.

The acknowledgment TCP packet may be generated based on at least one of capability information of the terminal, information on a size of a reception buffer of the TCP server, or the information on the size of the data included in the data TCP packet(s).

The processing method may further comprise: receiving a connection termination TCP packet from the TCP client; transmitting the connection termination TCP packet to the base station; in response to receiving the connection termination TCP packet, transmitting, to the base station, a first PDCP message including PDCP TCP context deletion preparation request information; and receiving, from the base station, a second PDCP message including information indicating that a PDCP TCP context of the base station is ready to be deleted.

The processing method may further comprise: in response to receiving an acknowledgment TCP packet for TCP connection termination from the TCP client, transmitting the acknowledgment TCP packet to the base station; in response to transmitting the acknowledgment TCP packet for TCP connection termination, transmitting, the base station, a third PDCP TCP message requesting deletion of the PDCP TCP context; and deleting the PDCP TCP context.

According to a second exemplary embodiment of the present disclosure, a processing method in a PDCP of a base station may comprising: receiving a connection request TCP packet from a terminal; transmitting the connection request TCP packet to a TCP server; receiving an initial PDCP TCP context message requesting creation of a PDCP TCP context from the terminal; in response to receiving a connection permission TCP packet from the TCP server, transmitting the connection permission TCP packet to the terminal; creating the PDCP TCP context; in response to receiving the connection permission TCP packet, generating a connection establishment TCP packet to be transmitted to the TCP server; and transmitting the connection establishment TCP packet to the TCP server, wherein the PDCP TCP context is a context for performing at least part of a TCP procedure in advance.

The processing method may further comprise: receiving, from the terminal, data TCP packet(s) including data to be transmitted to the TCP server; transmitting the received data TCP packet(s) to the TCP server; and in response to receiving an acknowledgment TCP packet for the data TCP packet(s) from the TCP server, discarding the acknowledgment TCP packet.

The processing method may further comprise: receiving a connection termination TCP packet from the terminal; transmitting the connection termination TCP packet to the TCP server; receiving a first PDCP message including PDCP TCP context deletion preparation request information from the terminal; and in response to the first PDCP message, transmitting, to the terminal, a second PDCP message including information indicating that the PDCP TCP context is ready to be deleted.

The processing method may further comprise: receiving an acknowledgment TCP packet for TCP connection termination from the TCP server; and transmitting the acknowledgment TCP packet to the terminal.

The processing method may further comprise: receiving the acknowledgment TCP packet for the TCP connection termination from the terminal; transmitting the acknowledgment TCP packet to the TCP server; receiving, from the terminal, a third PDCP TCP message requesting deletion of the PDCP TCP context; and in response to the third PDCP message, deleting the PDCP TCP context.

According to a third exemplary embodiment of the present disclosure, a terminal may comprise at least one processor, and the at least one processor may cause the terminal to perform: receiving a connection request TCP packet from a TCP client of the terminal; transmitting the connection request TCP packet to a base station; creating an initial PDCP TCP context to perform at least part of a TCP procedure in advance; transmitting the initial PDCP TCP context to the base station; receiving a connection permission TCP packet from a TCP server through the base station; delivering the connection permission TCP packet to the TCP client; receiving a response to the initial PDCP TCP context from the base station; and in response to receiving a connection establishment TCP packet from the TCP client, discarding the received connection establishment TCP packet.

The at least one processor may further cause the terminal to perform: obtaining information on a size of a reception buffer of the TCP server included in the connection permission TCP packet.

The at least one processor may further cause the terminal to perform: receiving, from the TCP client, data TCP packet(s) including data to be transmitted to the TCP server; obtaining information on a size of the data included in the data TCP packet(s); transmitting the data TCP packet(s) to the base station; generating an acknowledgment TCP packet corresponding to the data TCP packet(s) transmitted to the base station; and transmitting the acknowledgment TCP packet to the TCP client.

The acknowledgment TCP packet may be generated based on at least one of capability information of the terminal, information on a size of a reception buffer of the TCP server, or the information on the size of the data included in the data TCP packet(s).

The at least one processor may further cause the terminal to perform: receiving a connection termination TCP packet from the TCP client; transmitting the connection termination TCP packet to the base station; in response to receiving the connection termination TCP packet, transmitting, to the base station, a first PDCP message including PDCP TCP context deletion preparation request information; and receiving, from the base station, a second PDCP message including information indicating that a PDCP TCP context of the base station is ready to be deleted.

The at least one processor may further cause the terminal to perform: in response to receiving an acknowledgment TCP packet for TCP connection termination from the TCP client, transmitting the acknowledgment TCP packet to the base station; in response to transmitting the acknowledgment TCP packet for TCP connection termination, transmitting, the base station, a third PDCP TCP message requesting deletion of the PDCP TCP context; and deleting the PDCP TCP context.

In accordance with an exemplary embodiment of the present disclosure, it becomes possible to address issues like TCP retransmissions or speed limitations that may occur in high-latency mobile communication systems, such as those in non-terrestrial networks. Furthermore, the inclusion of the terminal's capability information in a TCP option at the transport layer of the terminal provides an advantage in actively controlling TCP packets.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a hierarchical structure of a user plane between a terminal and a base station in the 3GPP communication system.

FIG. 4 is a sequence chart illustrating a communication procedure between a server and a client in an application of a communication system.

FIG. 5 is a sequence chart illustrating a data transmission/reception procedure between an application server and an application client in a TCP communication system.

FIG. 6A is a part of a sequence chart illustrating a TCP data transmission/reception procedure between an application server and an application client using PDCP layers of a mobile communication system.

FIG. 6B is another part of the sequence chart illustrating the TCP data transmission/reception procedure between the application server and the application client using PDCP layers of the mobile communication system.

FIG. 6C is the remaining part of the sequence chart illustrating the TCP data transmission/reception procedure between the application server and the application client using PDCP layers of the mobile communication system.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

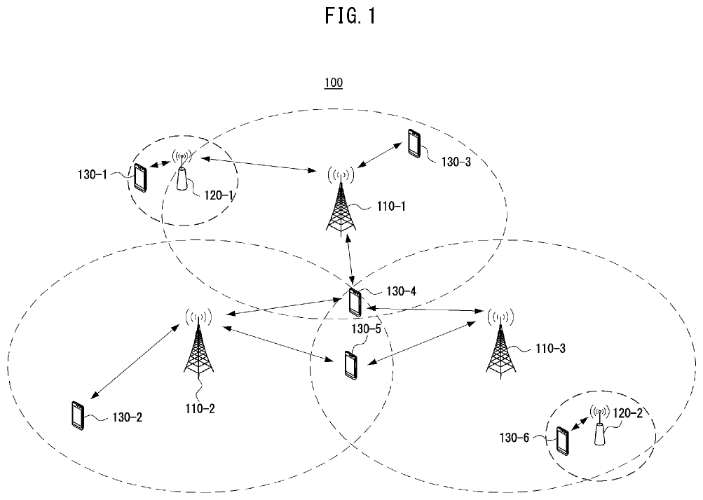

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g. long term evolution (LTE), LTE-advanced (LTE-A)), 5th generation (5G) communication (e.g. new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

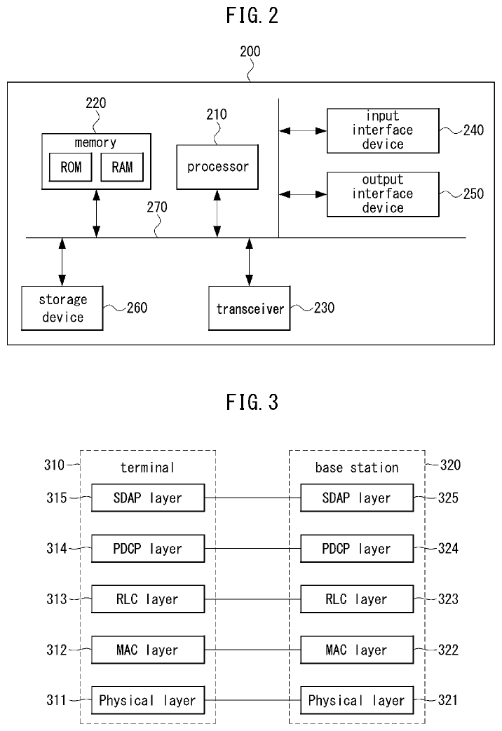

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g. a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

FIG. 3 is a conceptual diagram illustrating a hierarchical structure of a user plane between a terminal and a base station in the 3GPP communication system.

A terminal 310 may include a physical layer 311, MAC layer 312, RLC layer 313, PDCP layer 314, and SDAP layer 315.

The physical layer 311 may be a layer located at a bottom of an Open Systems Interconnection (OSI) stack, and may transmit/receive information from a higher layer (e.g. layer 2 (L2)) through a wireless medium. The physical layer 311 may perform processing such as modulation/demodulation and coding/decoding of signals to transmit information of the higher layer through the wireless medium.

The MAC layer 312 may perform mapping between logical channels and transport channels, multiplexing/demultiplexing of MAC SDU(s) belonging to one or different logical channels to a transport block (TB) delivered to the physical layer through transport channels, scheduling information reporting, HARQ-based error correction, prioritization between terminals (e.g. UEs) through dynamic scheduling, prioritization between logical channels of one terminal, prioritization when resources of one terminal overlap, padding, and the like.

The RLC layer 313 may support three modes: a transparent mode (TM), an unacknowledged mode (UM) that does not transmit acknowledgment (ACK) signals, and an acknowledged mode (AM) that transmits ACK signals, and support an automatic repeat request (ARQ) function. Further, according to the three modes, the RLC layer 313 may perform operations such as designation of sequence numbers independent of PDCP sequence numbers, ARQ-based error correction, segmentation and re-segmentation of RLC SDUs, reassembly of SDU, duplicate detection, RLC SDU discard, RLC re-establishment, protocol error detection, and the like.

The PDCP layer 314 may perform operation such as data transmission of the user plane or control plane, maintenance of PDCP SNs, header compression and decompression using a robust header compression (ROHC) protocol, header compression and decompression using an Ethernet header compression (EHC) protocol, compression and decompression of uplink PDCP SDUs, ciphering and deciphering, integrity protection and integrity verification, timer-based SDU discard, routing for split bearers, duplication, and the like.

The SDAP layer 315 included in the user plane may perform mapping between Qos flows and data radio bearers, marking of QoS flow IDs (QFIs) for both downlink (DL) and uplink (UL) packets, and the like, and a single SDAP protocol entity may be configured for each individual PDU session.

A base station 320 may include a physical layer 321 corresponding to the physical layer 311 of the terminal 310, a MAC layer 322 corresponding to the MAC layer 312 of the terminal 310, an RLC layer 323 corresponding to the RLC layer 313 of the terminal 310, a PDCP layer 324 corresponding to the PDCP layer 314 of the terminal 310, and an SDAP layer 325 corresponding to the SDAP layer 315 of the terminal 310. Each of the layers 321, 322, 323, 324, and 325 included in the base station 320 may perform the same operations as the operations of the corresponding layer of the terminal 310.

In the hierarchical structure illustrated in FIG. 3, a data flow and transmission operation assuming that user data destined for the terminal 310 is received by the base station 320 from the network will be described. In addition, the following description will be made assuming that the terminal 310 is in a radio resource control (RRC) active state.

When user data (e.g. IP packet) destined for the terminal 310 is received by the base station 320 from a higher layer of the network (e.g. user plane function (UPF)), the SDAP layer 325 of the base station 320 may mark a downlink packet with a QFI based on a QoS flow of the IP packet, and deliver it to the PDCP layer 324 of the base station 320.

The PDCP layer 324 may receive an SDU from the SDAP layer 325, assign a sequence number thereto, and deliver a protocol data unit (PDU) on which ciphering and integrity processing have been performed to the RLC layer 323.

The RLC layer 323 may segment the SDU and assign an independent sequence number thereto, which is different from the PDCP SN. Then, the RLC layer 323 may copy the segmented SDUs and store them in a buffer for retransmission, and deliver a PDU comprising an RLC header and the segmented SDU to the MAC layer 322.

The MAC layer 322 may multiplex the SDUs received from the RLC layer 323 into a transport block (TB) for delivering the SDUs to the physical layer based on the mapping information between logical channels and transport channels, and deliver the TB to the physical layer 321.

The physical layer 321 may encode and modulate the TB received from the MAC layer 322, and transmit it to the terminal 310 over a radio channel.

The terminal 310 may receive the IP packet through the physical layer 311, MAC layer 312, RLC layer 313, PDCP layer 314, and SDAP layer 315, based on a reverse procedure of the operations described above.

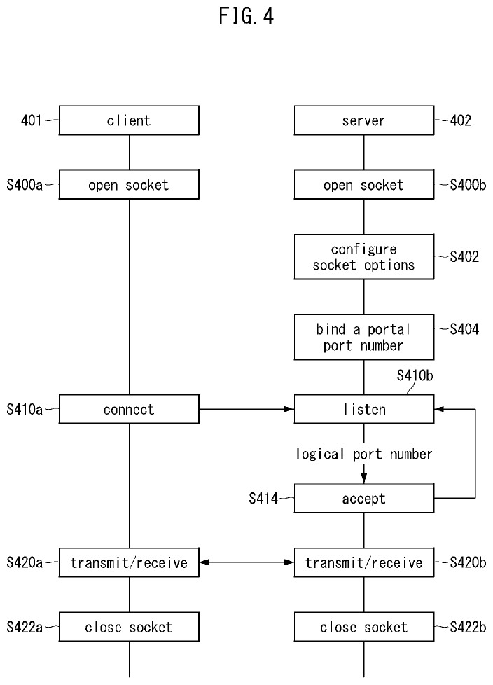

FIG. 4 is a sequence chart illustrating a communication procedure between a server and a client in an application of a communication system.

A client 401 in FIG. 4 may be a client of an application mounted on the terminal. In addition, the server 402 may operate as a server for the application mounted on the terminal. The server illustrated in FIG. 4 may be a web server or a file server.

Referring to FIG. 4, the client 401 may open a socket (S400a). In addition, the server 402 may open a socket (S400b). Although the steps S400a and S400b are both illustrated as being performed at the same time in FIG. 4, the socket may be actually opened first in the server 402. In other words, the server 402 may open the socket and perform subsequent procedures. The client 401 may open the socket when it is necessary to transmit or receive data.

The server 402 may configure socket options (S402). The procedure for configuring socket options may be a procedure for configuring a TCP socket or creating another socket. Hereinafter, description will be made assuming the case of configuring a TCP socket.

The server 402 may bind a portal port number (S404). The step S404 may be a procedure in which the server 402 assigns a portal port number to the socket using a bind function.

The server 402 may wait for an access of a client using a listen function (S410b). In general, since a plurality of clients can access the server 402, a port number used in the step S410b may be a general portal port number to listen for accesses of clients. For example, the general portal port may include a port 80 or a port 21, which are widely used in TCP/IP communication.

The server 402 may open the socket by performing the step S400b described above, assign the port number to the socket using the bind function in the step S402, and then perform a listening mode in the step S404.

The socket open procedure in the step S400a may be a socket open procedure performed when the client 401 needs to communicate with the server 402, that is, when the client 401 transmits data to the server 402 or when the client 401 requests transmission of data from the server 402. In addition, as described above, the server 402 may has been already in the listening mode.

The client 401 may attempt to connect to the server 402 (S410a). Therefore, the server 402, which in in the listening mode, may detect a connection attempt from the client 401 (S410b). When the server 402 detects the connection attempt from the client 401, it may assign a new logical port number. This is because the port of the server 402, through which the client 401 attempts to connect to the server 402, is a general portal port. Accordingly, the server 402 may assign a new logical port number to the client 401, which has attempted to connect, in order to listen to connection attempts from other clients. Therefore, the server 402 may continue to listen to connection attempts from other clients using the same general portal port.

The server 402 may accept the socket connection of the client 401 using the logical port number assigned to the client 401 (S414). When the server 402 is connected to the socket of the client 401 using the specific logical port number as described above, the client 401 and the server 402 may perform data transmission/reception in steps S420a and S420b. In this case, the data transmission/reception may use functions ‘send’ and ‘recv’.

When the data transmission/reception between the client 401 and the server 402 is completed, the client 401 and the server 402 may each terminate the connection through a socket close operation in steps S422a and S422b.

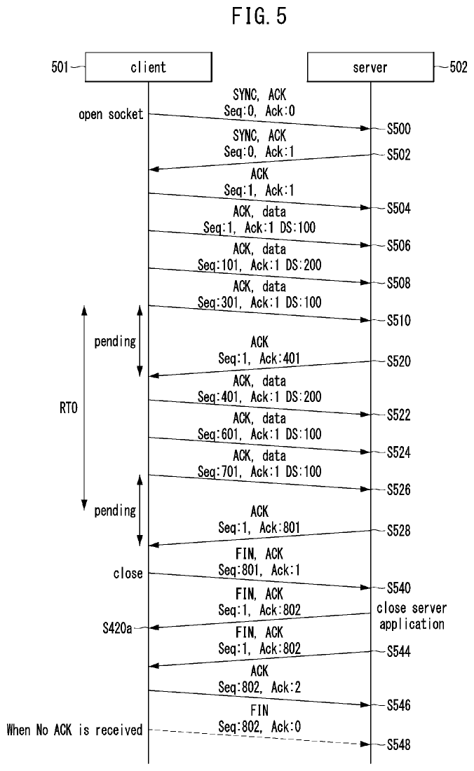

FIG. 5 is a sequence chart illustrating a data transmission/reception procedure between an application server and an application client in a TCP communication system.

A client 501 in FIG. 5 may be a client of an application mounted on the terminal. In addition, a server 502 may operate as a server for the application mounted on the terminal. The server illustrated in FIG. 5 may be a web server or a file server.

The client 501 of the terminal may transmit a ‘connection request TCP packet’ for a connection request to the server 502 based on an opened socket. The connection request TCP packet may have a set TCP control flag and a SYNC flag set to ′1. The connection request TCP packet does not include any data. In a header of the connection request TCP packet, a TCP sequence (Seq) number may be set to ‘0’, and an acknowledgment (Ack) number may be set to ‘0’. FIG. 5 illustrates a case where the TCP sequence number (Seq) of the connection request TCP packet is set to ‘0’ and the Ack number is set to ‘0’.

Accordingly, the server 502 may receive the connection request TCP packet from the client 501 of the terminal (S500). The server 502 may confirm that the SYNC flag is set in the control flag of the received connection request TCP packet, and may identify (Seq:0 and Ack:0) in the header of the connection request TCP packet. Accordingly, the server 502 may confirm that the client 501 wishes to connect to the server.

Since the server 502 has received the connection request, the server 502 may generate a ‘connection permission TCP packet’ (S502). The connection permission TCP packet may include a set SYNC flag that is a TCP control flag and set an Ack number set to ‘1’. In addition, a Seq number included in a header of the TCP packet may be set to ‘0’ because there is no data in the previously received connection request TCP packet. In addition, the server 502 may further include information on the size of a reception buffer in the connection permission TCP packet. This may be information for the client 501 to transmit data based on the size of the buffer configured in the server 502 when transmitting data. Therefore, the server 502 may set the SYNC flag indicating connection permission and generate the connection permission TCP packet with (Seq:0 and Ack:1) configured in the header. The server 502 may transmit the connection permission TCP packet to the client 501 (S502).

Accordingly, the client 501 may receive the connection permission TCP packet (S502). Upon receiving the connection permission TCP packet, the client 501 may identify that data transmission/reception with the server 502 is possible and identify the maximum size of data that can be transmitted based on the information on the reception buffer included in the connection permission TCP packet.

The client 501 may transmit a ‘connection establishment TCP packet’ to the server 502 in response to the connection permission TCP packet (S504). Because a circuit has already been configured, the connection establishment TCP packet may be transmitted with an ACK flag set to ‘1’. Therefore, a header of the connection establishment TCP packet may be set to (Seq:1 and Ack:1). The server 502 may receive the connection establishment TCP packet (S504). Thereafter, the server 502 may wait to receive data, that is, a TCP packet, from the client 501.

The operations described above, that is, the operations of steps S500 to S504, are referred to as a ‘3-way handshake process’. Through the above procedure, the connection between the client 501 and the server 502 may be established, and options between the client 501 and the server 502 may be configured.

The client 501 (i.e. application) may transmit data to the server 502 in steps S506 to S510. Since the client 501 knows the size of the reception buffer of the server 502, it may continuously transmit data within the size of the reception buffer. In FIG. 5, an example is provided assuming that three data units are transmitted in succession.

The client 501 may transmit a TCP packet including first data to the server 502 (S506). In this case, a header of the transmitted TCP packet may include a Seq number, Ack number, and information on a data size (DS), and it is assumed that DS is 100. Then, the Seq number, Ack number, and DS included in the header of the TCP packet transmitted in the step S506 may be set as (Seq:1, Ack:1, and DS:100).

The client 501 may transmit a TCP packet including second data to the server 502 (S508). In this case, it is assumed that a DS of the transmitted TCP packet is 200. In addition, a Seq number may be increased by adding a value of a packet size of the previous TCP transmission. Therefore, the Seq number, Ack number, and DS included in the TCP packet header transmitted in the step S508 may be set as (Seq: 101, Ack:1, and DS:200).

The client 501 may transmit a TCP packet including third data to the server 502 (S510). In this case, it is assumed that a DS of the TCP packet illustrated in step S510 is 100. In addition, as described above, a Seq number may be increased by adding a value of a packet size of the previous TCP transmission. Therefore, the Seq number, Ack number, and DS included in the TCP packet header transmitted in the step S510 may be set as (Seq:301, Ack:1, and DS:100).

After transmitting the three TCP packets based on the size of the reception buffer, the client 501 may be pending data transmission. In this case, the client 501 may operate a timer set to a retransmission timeout (RTO) time. TRO may be a time set to receive a response corresponding to the data transmitted in the steps S506 to S510.

Meanwhile, the server 502 may receive the TCP packets from the client 501 through the steps S506 to S510. In FIG. 5, it is assumed that the server 502 normally receives the TCP packets from the client 501. When the server 502 normally receives the TCP packet, the server 502 may generate an ‘ACK TCP packet’ to be transmitted to the client 501. Here, a header of the ACK TCP packet may include a Seq number and an Ack number. The Ack number transmitted by the server 502 may inform the cumulative size of data received by the server 502 to date, and may indicate a value of the next segment expected by the server 502. Therefore, if the server 502 correctly receives all of the data in the steps S506 to S510, the size of the received cumulative data may be 400, and the next segment value 401 expected by the server 502 may be set to the Ack number.

The server 502 may transmit the ACK TCP packet to the client 501 (S520). In this case, the Seq number and Ack number of the ACK TCP packet header may be set as (Seq: 1 and Ack:401). Since the ACK TCP packet does not include data, a DS is not configured therein. Accordingly, the client 501 may receive the ACK TCP packet from the server 502 (S520). The client 501 may determine that the transmitted TCP packet is normally received by the server 502 by identifying the header of the ACK TCP packet received from the server 502.

The client 501 receiving the ACK TCP packet in the step S520 may resume data transmission again. Therefore, the running RTO timer may be reset.

The client 501 may transmit data to the server 502 in steps S522 to S526. As described above, since the client 501 knows the size of the reception buffer of the server 502, it may continuously transmit data within the size of the reception buffer. Even in this case, it may be assumed that the client 501 continuously transmits data three times as described above.

The client 501 may transmit a TCP packet including fourth data to the server 502 (S522). A Seq number, Ack number, and DS included in the TCP packet header transmitted in the step S522 may be set as ‘Seq:401, Ack: 1, and DS:200’. In the step S522, the DS of the TCP packet is 200, and the Seq number is accumulated from previous transmissions, so it may have a value of 401.

The client 501 may transmit a TCP packet including fifth data to the server 502 (S524). A Seq number, Ack number, and DS included in the TCP packet header transmitted in the step S524 may be set as ‘Seq:601, Ack: 1, and DS: 100’. In the step S522, the DS of the TCP packet is 100, and the Seq number is accumulated from previous transmissions, so it may have a value of 601.

The client 501 may transmit a TCP packet including sixth data to the server 502 (S526). A Seq number, Ack number, and DS included in the TCP packet header transmitted in the step S526 may be set as (Seq: 701, Ack: 1, and DS: 100). In the step S526, the DS of the TCP packet is 100, and the Seq number is accumulated from previous transmissions, so it may have a value of 701. Thereafter, the client 501 may be pending data transmission.

The server 502 may receive the TCP packets from the client 501 through the steps S522 to S526. When the server 502 normally receives the TCP packet, the server 502 may generate an ‘ACK TCP packet’ to be transmitted to the client 501. An Ack number transmitted by the server 502 may inform the size of cumulative data received by the server 502 to date, and the Ack number may be set to 801.

The server 502 may transmit the ACP TCP packet to the client 501 (S528). The Seq number and Ack number included in the header of the ACK TCP packet may be set as (Seq:1 and Ack: 801). Therefore, the client 501 may receive the ACK TCP packet (S528).

Thereafter, the client 501 may close the socket after the data transmission is completed. The client 501 may generate a connection termination TCP packet and transmit it to the server 502. The connection termination TCP packet may inform the termination of the TCP connection by setting a connection termination (FIN) flag in the header. In this case, the header of the connection termination TCP packet may include a Seq number and an Ack number. The Seq number and Ack number included in the header of the connection termination TCP packet may be set as (Seq:801, Ack:1). Therefore, the server 502 may receive the connection termination TCP packet (S540).

The server 502 receiving the connection termination TCP packet in the step S540 may close the server application. The server 502 may transmit a connection termination ACK TCP packet to the client 501 (S544). The client 501 may receive the connection termination ACK TCP packet (S544). In response, the client 501 may transmit an ACK TCP packet again to the server 502 (S546). Through the above procedure, the client 501 may close the socket and terminate communication.

Meanwhile, when the ACK is not received in the step S546, the client 501 may retransmit the connection termination TCP packet (S548). In this case, a header of the connection termination TCP packet may be configured differently from the header of the connection termination TCP packet previously transmitted in the step S540. The header of the connection termination TCP packet transmitted in the step S548 may be transmitted with the sequence number and Ack number set as (Seq: 2, Ack: 0).

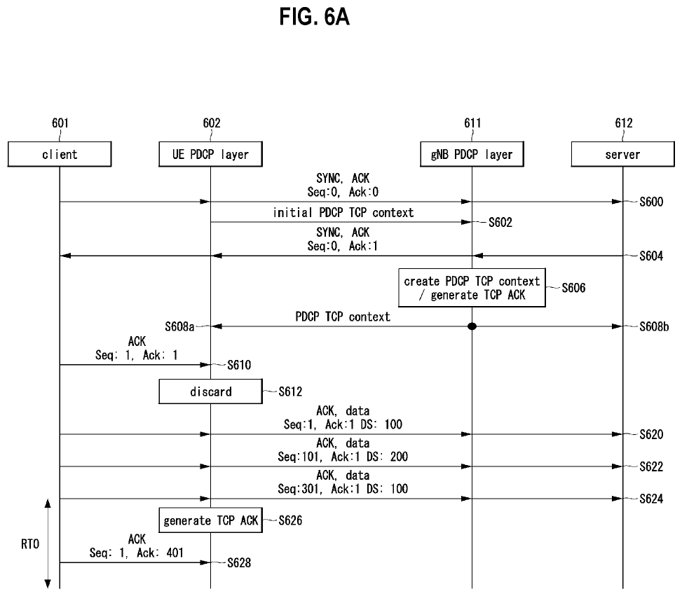

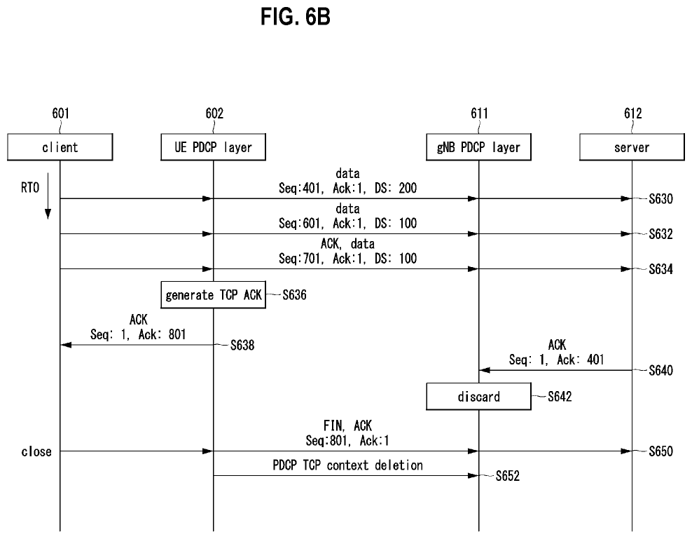

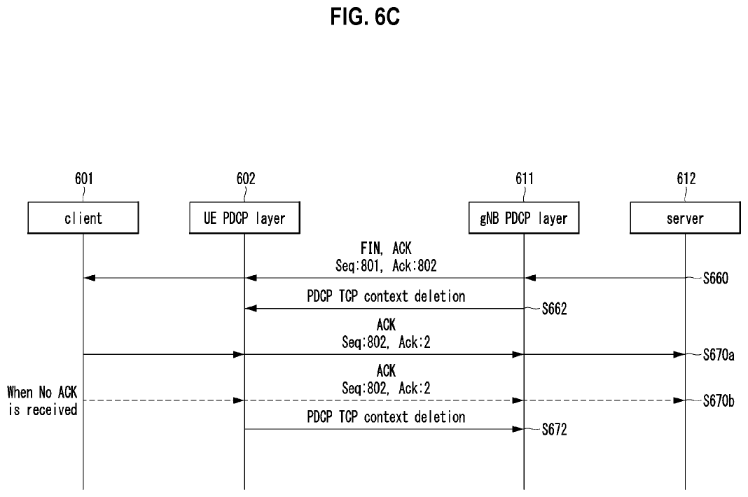

FIG. 6A is a part of a sequence chart illustrating a TCP data transmission/reception procedure between an application server and an application client using PDCP layers of a mobile communication system, FIG. 6B is another part of the sequence chart illustrating the TCP data transmission/reception procedure between the application server and the application client using PDCP layers of the mobile communication system, and FIG. 6C is the remaining part of the sequence chart illustrating the TCP data transmission/reception procedure between) the application server and the application client using PDCP layers of the mobile communication system.

In FIGS. 6A to 6C, a client 601 may be a client of an application mounted on the terminal (i.e. UE), and a UE PDCP layer 602 may be the PDCP layer of the terminal previously described in FIG. 3. In addition, the client 601 may be a TCP client. In the present disclosure, for convenience of description, it is assumed that the client 601 is a TCP client. A gNB PDCP layer 611 may be the PDCP layer included in the base station in FIG. 3. The server 612 may correspond to the server 501 described in FIG. 5. Accordingly, the server 611 may operate as a server for the application mounted on the terminal, and may be a web server or a file server. Meanwhile, as described above, the present disclosure may be applied to a case where a transmission delay is large in Non-Terrestrial Networks (NTN) such as satellite communication. In this case, the gNB PDCP layer 611 may be located in different places depending on the characteristics of the satellite. For example, if the satellite is a transparent satellite, the PDCP layer 611 may be located in a gateway or a gNB connected to the gateway. If the satellite is a regenerative satellite, the PDCP layer 611 may be located in the satellite, or may be located in a gateway or a gNB connected to the gateway. For convenience of description, the following description will assume that the PDCP layer 611 is located in the gNB.

Meanwhile, the terminal including the client 601 and the PDCP layer 602 and the base station including the gNB PDCP layer illustrated in FIGS. 6A to 6C may include all or at least part of the components described in FIG. 2. For example, both the terminal and the base station may include the processor 210, memory 220, and transceiver 230. In addition, in case of the terminal, the processor 210 may be divided into an application processor (AP) executing the TCP client, and a communication processor (CP) performing operations of the physical layer 311, MAC layer 312, RLC layer 313, PDCP layer 314, and SDAP layer 315 as illustrated in FIG. 3. When the processor 210 is divided into the AP and CP, they may be referred to as a first processor and a second processor, respectively. In case of the terminal, in addition to the components illustrated in FIG. 2, it may further include various components for user convenience. For example, it may further include a component for providing a graphic user interface (GUI) and/or various sensors. In case of the base station, it may further include an interface for communication with a higher level network and/or an interface for communication between base stations.

Hereinafter, operations of FIGS. 6A to 6C will be sequentially described. In addition, when describing the operations of FIGS. 6A to 6C, it should be noted that a transmitted TCP packet will be described using the same content as previously described in FIG. 5. In addition, the operations of FIGS. 6A to 6C will be described with reference to other previously described drawings.

In addition, before describing FIGS. 6A to 6C, it is assumed that a wireless link capable of communicating between the UE PDCP layer 602 and the gNB PDCP layer 611 is established. In other words, the terminal may be in the RRC active state. Therefore, it is assumed that downlink (DL) and uplink (UL) are established between the terminal and the base station gNB. In other words, the gNB may be a serving base station for the terminal.

The client 601 may deliver a connection request TCP packet to the UE PDCP layer 602 based on an opened socket. Then, the UE PDCP layer 602 may transmit the connection request TCP packet to the gNB PDCP layer 611. In this case, the procedure for transmission from the UE PDCP layer 602 to the gNB PDCP layer 611 may follow the procedure previously described in FIG. 3. The gNB PDCP layer 611 may transmit the connection request TCP packet received from the UE PDCP layer 602 to the server 612. In this case, value(s) set in a header of the connection request TCP packet may be set identically to those previously described in FIG. 5.

The UE PDCP layer 602 may identify a SYNC flag set in the header of the connection request TCP packet from the client 601, and may confirm that the client 601 wishes to activate a TCP socket to communicate with the server 612 (S600).

Based on the above confirmation, the UE PDCP layer 602 may generate an initial PDCP TCP context initialization packet and transmits a context created as a PDCP status PDU to the gNB PDCP layer 611 (S602). In this case, PDCP TCP context setup may be done when configuring a data radio bearer (DRB). The DRB may generally be configured through RRC signaling or MAC CE from a network, for example, from the base station. Therefore, in the step S602, the gNB PDCP layer 611 may receive the initial PDCP TCP context included in the PDCP status PDU received from the UE PDCP layer 602. Therefore, the gNB PDCP layer 611 may recognize context creation for TCP packets based on the received initial PDCP TCP context. In the present disclosure, the initial PDCP TCP context may be information requesting the PDCP layers to create the context for TCP processing. In other words, the initial PDCP TCP context may be an initial setup process for creating the TCP context between the PDCP layers.

Meanwhile, in FIG. 6A, it is assumed that the steps S600 and S602 are performed sequentially. However, in actual operations, the connection request TCP packet in the step S600 and the PDCP TCP context in the step S602 may be transmitted simultaneously.

The server 612 may generate a connection permission TCP packet as previously described in FIG. 5 and transmit it to the gNB PDCP layer 611 (S604). In this case, the connection permission TCP packet may include information on the size of the reception buffer of the server 612, as previously described in FIG. 5. Then, the gNB PDCP layer 611 may transmit the connection permission TCP packet to the UE PDCP layer 602 through a wireless link. The UE PDCP layer 602 receiving the connection permission TCP packet may transmit it to the client 601. Accordingly, the client 601 may receive the connection permission TCP packet and create a TCP socket. In addition, the client 601 may identify the size of the reception buffer of the server 612 included in the received connection permission TCP packet. In this case, the UE PDCP layer 602 may also identify the size of the reception buffer of the server 612 based on the connection permission TCP packet received from the server 612 through the gNB PDCP layer 611.

Meanwhile, when the gNB PDCP layer 611 according to the present disclosure receives the connection permission TCP packet in the step S604, it may confirm that the received packet is the connection permission TCP packet by checking the header of the connection permission TCP packet.

The gNB PDCP layer 611 may create the PDCP TCP context in response to the initial PDCP TCP context received in step S602, and generate a connection establishment TCP packet in response to the connection permission TCP packet received in step S604 (S606). Here, the connection establishment TCP packet may be the same TCP packet as the connection establishment TCP packet generated by the client 501, as previously described in step S504 of FIG. 5.

The gNB PDCP layer 611 may transmit the PDCP TCP context created in the step S606 to the UE PDCP layer 602 through downlink (S608a). In the step S608a, the UE PDCP layer 602 may maintain the PDCP TCP context transmitted to the gNB PDCP layer 611 in the step S602 by receiving the PDCP TCP context from the gNB PDCP layer 611. In other words, the UE PDCP layer 602 may transmit the initial PDCP TCP context in step S602, allowing the gNB PDCP layer 611 to create the PDCP TCP context, and the gNB PDCP layer 611 may transmit a response for the creation of the PDCP TCP context to the UE PDCP layer 602. Through this, the UE PDCP layer 602 and the gNB PDCP layer 611 may each perform some operations of the TCP procedure according to the present disclosure. This will be described in more detail with reference to the following sequence chart.

In addition, the gNB PDCP layer 611 may transmit the generated connection establishment TCP packet to the server 612 (S608b). In the present disclosure, by having the gNB PDCP layer 611 transmit the connection establishment TCP packet to the server 612, the procedure can be simplified and a time required therefor can be reduced compared to the case where the client 601 of the terminal generates and transmits the packet.

Meanwhile, it has been exemplified that the steps S608a and S608b are performed simultaneously. However, either step S608a or step S608b may be performed first, and the remaining step may be performed later.

The client 601 may generate a connection establishment TCP packet in response to receiving the connection permission TCP packet received in the step S604 (S610). The client 601 may transmit the generated connection establishment TCP packet to the UE PDCP layer 602. Accordingly, the UE PDCP layer 602 may receive the connection establishment TCP packet from the client 601 (S610).

The UE PDCP layer 602 may discard the received connection establishment TCP packet (S612). This is because the UE PDCP layer 602 is in a state of knowing that the gNB PDCP layer 611 has already transmitted the connection establishment TCP packet to the server 612. In the steps S602 and S608a, the PDCP TCP context between the UE PDCP layer 602 and the gNB PDCP layer 611 may be pre-arranged through configuration or may be announced through signaling between the terminal and the gNB. Meanwhile, if the connection establishment TCP packet is piggybacked, the UE PDCP layer 602 may delete the connection establishment TCP packet, recalculate a checksum of the TCP header, and transmit it as data to the gNB DPCP layer 611. Through the procedures described above, the ‘3-way handshake process’ previously described in FIG. 5 may be completed.

The client 601 may transmit data to the server 612 in steps S620 to S624. Since the client 601 knows the size of the reception buffer of the server 612, the client 601 may continuously transmit data within the size of the reception buffer. In FIGS. 6A to 6C, a case in which three rounds of data are transmitted in succession as previously described in FIG. 5 is assumed as an example. In other words, the steps S620 to S624 illustrated in FIG. 6A may correspond to the steps S506 to S510 previously described in FIG. 5. In the following description, for convenience of description, TCP packets for data transmission will be referred to as data TCP packets.

A difference between FIG. 5 and FIGS. 6A to 6C is only that transmission/reception between the client 601 and the server 612 are performed through the UE PDCP layer 602 and the gNB PDCP layer 611. Therefore, since the description thereof overlaps with FIG. 5, it will be omitted. In addition, the client 601 may set a preset RTO timer and drive the RTO timer.

Meanwhile, the UE PDCP layer 602 may determine a time of generating a TCP ACK based on a DS of the TCP packet transmitted from the client 601 to the server 612 through the UE PDCP layer 602 and the gNB PDCP layer 611 in the illustrated steps S620 to S624 and the size of the reception buffer of the server 612 obtained in the step S604. In this case, when generating the TCP ACK, load control may be performed by referring to the terminal's transmission capability (i.e. UE capability) and considering the size of the reception buffer. In addition, a DL and a UL of the mobile communication system may be configured between the UE PDCP layer 602 and the gNB PDCP layer 611 as described above. In addition, in DL and/or UL wireless communication between the base station and the terminal, an HARQ-based error correction function may be applied between the MAC layer 312 of the terminal and the MAC layer 322 of the base station. In addition, the ARQ function may be applied between the RLC layer 313 of the terminal and the RLC layer 323 of the base station. It should be noted that error correction and retransmission procedures performed in UL and DL wireless links are not illustrated in FIGS. 6A to 6C. Also, it is assumed that data transmitted by the client 601 is transmitted through the UE PDCP layer 602 and the gNB PDCP layer 611 without errors based on error correction and retransmission procedures not illustrated in FIGS. 6A to 6C.

The UE PDCP layer 602 may determine to generate a TCP ACK based on the size of the transmitted data and the size of the reception buffer of the server 612, and generate a TCP ACK packet (S626). Here, the TCP ACK packet may mean the same packet as the ACK TCP packet previously described in the step S520 of FIG. 5. Therefore, a header of the TCP ACK packet generated in the step S626 may have the same as that described in FIG. 5. In other words, a Seq number and an Ack number of the ACK TCP packet header may be set as (seq:1 and Ack:401).

In this case, the UE PDCP layer 602 may determine a time of transmitting the ACK TCP packet. Therefore, the step S626 may be performed based thereon before the time of transmitting the ACK TCP packet. The time of transmitting the ACK TCP packet may be determined based on the previously received information on the size of the reception buffer of the server 612 as well as the transmission capability of the terminal based on UE Capability information. Here, the UE capability information may be information provided in advance to the gNB based on a UE capability information inquiry from the gNB, or may be information previously held by the UE PDCP layer 602 or may information acquired on its own if necessary.

For example, if the amount of transmitted TCP packets exceeds a preset threshold based on the size of the reception buffer of the server and accumulation of the DSs, the UE PDCP layer 602 may generate an ACK TCP packet. As another example, if the terminal is in a state capable of transmitting additional data TCP packets based on the UE capability information, the UE PDCP layer 602 may generate the ACK TCP packet. The state capable of transmitting additional data TCP packets may be a state in which data exceeding a predetermined threshold is buffered in a transmission buffer. As another example, if data exceeding a predetermined threshold is buffered in the transmission buffer, whether to be capable of transmitting additional data TCP packets may be determined based on a state of an uplink channel allocated by the terminal to the terminal.

The UE PDCP layer 602 may transmit the ACK TCP packet to the client 601 (S628). Accordingly, the client 601 may receive the ACK TCP packet. The UE PDCP layer 602 transmits the ACK TCP packet to the client 601, thereby preventing a time delay in receiving an ACK TCP packet from the server 612. In particular, as described above, when using a non-terrestrial network, it may take a very long time for an ACK TCP to be received from the server 612. However, according to the present disclosure, the UE PDCP layer 602 may prevent a time delay from occurring by transmitting the ACK TCP to the client 601.

The client 601 receiving the ACK TCP from the UE PDCP layer 602 in the step S628 may transmit TCP packets to the server 612 through steps S630 to S634. The steps S630 to S634 illustrated in FIG. 6B may correspond to the steps S522 to S526 previously described in FIG. 5. In this case, the difference therebetween may also be the same as previously described in the steps S620 to S624.

Accordingly, the UE PDCP layer 602 may determine a time of generating a TCP ACK based on a DS of the TCP packet transmitted from the client 601 to the server 612 through the UE PDCP layer 602 and the gNB PDCP layer 611 in the illustrated steps S630 to S634 and the size of the reception buffer of the server 612 obtained in the step S604.

The UE PDCP layer 602 may determine to generate a TCP ACK based on the size of the transmitted data and the size of the reception buffer of the server 612, and generate a TCP ACK packet (S636). Here, the TCP ACK packet may mean the same packet as the ACK TCP packet previously described in the step S528 of FIG. 5. Therefore, a header of the TCP ACK packet generated in the step S636 may have the same as that described in FIG. 5. In other words, a sequence number and an Ack number of the ACK TCP packet header may be set as (seq:1 and Ack:801).

Meanwhile, the server 612 may generate an ACK TCP packet for the TCP packet transmitted by the client 601 in the steps S620 to S624. The server 612 may transmit the ACK TCP packet to the gNB PDCP layer 611 for the TCP packet transmitted by the client 601 in the steps S620 to S624 (S640). Accordingly, the gNB PDCP layer 611 may receive the ACK TCP packet from the server 612 (S640). The gNB PDCP layer 611 may calculate a checksum for the transmitted packet by considering the sequence number stored in the PDCP TCP context, and deliver it to the server 612.

The gNB PDCP layer 611 may discard the received ACT TCP packet (S642). This is because it can be known or expected that the UE PDCP layer 602 has already transmitted an ACK TCP packet based on the PDCP TCP context described above. In other words, the gNB PDCP layer 611 may analyze the packet header received from the UE PDCP layer 602 and maintain ACK transmission values, discard the ACK packet received from the server 612, and maintain the PDCP TCP context values based on the received ACK.

When transmission of the TCP packet is completed, the client 601 may generate a connection termination TCP packet, and transmit it to the UE PDCP layer 602 (S650). In this case, the connection termination TCP packet may be the same as the connection termination TCP packet previously described in the step S540 of FIG. 5. The UE PDCP layer 602 may confirm connection termination based on reception of the connection termination TCP packet, and transmit the received connection termination TCP packet to the gNB PDCP layer 611 through a wireless channel. Accordingly, the gNB PDCP layer 611 may transmit the connection termination TCP packet received from the UE PDCP layer 602 to the server 612.

Since the UE PDCP layer 602 recognizes the connection termination TCP packet, the UE PDCP layer 620 may transmit a PDCP TCP context deletion message including information to prepare a PDCP TCP context deletion request to the gNB PDCP layer 611 (S652). This may be a message to notify that the UE PDCP layer 602 is preparing to delete the PDCP TCP context and to indicating the gNB PDCP layer 611 to prepare to delete the PDCP TCP context.

FIG. 6B illustrates the case where the connection termination TCP packet is transmitted in the step S650 and the PDCP TCP context deletion message is sequentially transmitted in the step S652. However, the steps S650 and S652 may be performed simultaneously. Based on the PDCP TCP context deletion preparation request information in the step S652, the gNB PDCP layer 611 may prepare to delete the PDCP TCP context.

Referring to FIG. 6C, the server 612 may transmit a connection termination ACK TCP packet to the gNB PDCP layer 611 in response to receiving the connection termination TCP packet in step S650 (S660). Then, the gNB PDCP layer 611 may transmit the connection termination ACK TCP packet to the UE PDCP layer 602 through a wireless channel. The UE PDCP layer 602 receiving the connection termination ACK TCP packet from the gNB PDCP layer 611 may deliver it to the client 601. This may correspond to the step S542 previously described in FIG. 5.

The gNB PDCP layer 611 may transmit a PDCP TCP context deletion message to the UE PDCP layer 602 indicating that it is ready to delete the PDCP TCP context based on the connection termination ACK TCP packet received from the server 612 and transmitted to the UE PDCP layer 602 (S662). The step S662 may also be performed together (simultaneously) with the step S660 as described above.

The client 601 receiving the connection termination ACK TCP packet in the step S660 may have confirmed termination of the TCP connection. Therefore, the client 601 may transmit an ACK TCP packet to the server 612 through the UE PDCP layer 602 and the gNB PDCP layer 611 (S670a). This may be the same as the ACK TCP packet transmitted to the server 502 in the step S546 of FIG. 5.

On the other hand, if the connection termination ACK TCP packet is not received in the step S660, the client 601 may retransmit the connection termination TCP packet to the server 612 through the UE PDCP layer 602 and the gNB PDCP layer 611 (S670b). The connection termination TCP packet retransmitted in the step S670b may be the same packet as the retransmitted packet described in the step S548 of FIG. 5.

The UE PDCP layer 602 may delete the PDCP TCP context and transmit a PDCP TCP context deletion message including PDCP TCP context deletion execution request information to the gNB PDCP layer 611 (S672). Accordingly, the UE PDCP layer 602 and the gNB PDCP layer 611 may each delete the PDCP TCP context. In other words, a time at which the PDCP TCP context is deleted from each of the UE PDCP layer 602 and the gNB PDCP layer 611 may be a time after the ACK TCP packet for the termination of TCP configuration is transmitted.

The PDCP TCP context described above may be dependent on an RB of the DRB and may be configured with source and destination IP addresses and TCP source and destination port numbers. When the RB is deleted, the TCP context may be automatically terminated. Therefore, PDCP TCP context establishment and release (or deletion) may be done when configuring and releasing the DRB.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A processing method in a packet data convergence protocol (PDCP) of a terminal, comprising:
receiving a connection request transmission control protocol (TCP) packet from a TCP client of the terminal;
transmitting the connection request TCP packet to a base station;
creating an initial PDCP TCP context to perform at least part of a TCP procedure in advance;
transmitting the initial PDCP TCP context to the base station;
receiving a connection permission TCP packet from a TCP server through the base station;
delivering the connection permission TCP packet to the TCP client;
receiving a response to the initial PDCP TCP context from the base station; and
in response to receiving a connection establishment TCP packet from the TCP client, discarding the received connection establishment TCP packet.

2. The processing method according to claim 1, further comprising: obtaining information on a size of a reception buffer of the TCP server included in the connection permission TCP packet.

3. The processing method according to claim 1, further comprising:
receiving, from the TCP client, data TCP packet(s) including data to be transmitted to the TCP server;
obtaining information on a size of the data included in the data TCP packet(s);
transmitting the data TCP packet(s) to the base station;
generating an acknowledgment TCP packet corresponding to the data TCP packet(s) transmitted to the base station; and
transmitting the acknowledgment TCP packet to the TCP client.

4. The processing method according to claim 3, wherein the acknowledgment TCP packet is generated based on at least one of capability information of the terminal, information on a size of a reception buffer of the TCP server, or the information on the size of the data included in the data TCP packet(s).

5. The processing method according to claim 1, further comprising:
receiving a connection termination TCP packet from the TCP client;
transmitting the connection termination TCP packet to the base station;
in response to receiving the connection termination TCP packet, transmitting, to the base station, a first PDCP message including PDCP TCP context deletion preparation request information; and
receiving, from the base station, a second PDCP message including information indicating that a PDCP TCP context of the base station is ready to be deleted.

6. The processing method according to claim 5, further comprising:
in response to receiving an acknowledgment TCP packet for TCP connection termination from the TCP client, transmitting the acknowledgment TCP packet to the base station;
in response to transmitting the acknowledgment TCP packet for TCP connection termination, transmitting, the base station, a third PDCP TCP message requesting deletion of the PDCP TCP context; and
deleting the PDCP TCP context.

7. A processing method in a packet data convergence protocol (PDCP) of a base station, comprising:
receiving a connection request Transmission Control Protocol (TCP) packet from a terminal;
transmitting the connection request TCP packet to a TCP server;
receiving an initial PDCP TCP context message requesting creation of a PDCP TCP context from the terminal;
in response to receiving a connection permission TCP packet from the TCP server, transmitting the connection permission TCP packet to the terminal;
creating the PDCP TCP context;
in response to receiving the connection permission TCP packet, generating a connection establishment TCP packet to be transmitted to the TCP server; and
transmitting the connection establishment TCP packet to the TCP server,
wherein the PDCP TCP context is a context for performing at least part of a TCP procedure in advance.

8. The processing method according to claim 7, further comprising:
receiving, from the terminal, data TCP packet(s) including data to be transmitted to the TCP server;
transmitting the received data TCP packet(s) to the TCP server; and
in response to receiving an acknowledgment TCP packet for the data TCP packet(s) from the TCP server, discarding the acknowledgment TCP packet.

9. The processing method according to claim 7, further comprising:
receiving a connection termination TCP packet from the terminal;
transmitting the connection termination TCP packet to the TCP server;
receiving a first PDCP message including PDCP TCP context deletion preparation request information from the terminal; and
in response to the first PDCP message, transmitting, to the terminal, a second PDCP message including information indicating that the PDCP TCP context is ready to be deleted.

10. The processing method according to claim 9, further comprising:
receiving an acknowledgment TCP packet for TCP connection termination from the TCP server; and
transmitting the acknowledgment TCP packet to the terminal.

11. The processing method according to claim 10, further comprising:
receiving the acknowledgment TCP packet for the TCP connection termination from the terminal;
transmitting the acknowledgment TCP packet to the TCP server;
receiving, from the terminal, a third PDCP TCP message requesting deletion of the PDCP TCP context; and
in response to the third PDCP message, deleting the PDCP TCP context.

12. A terminal comprising at least one processor,
wherein the at least one processor causes the terminal to perform:
receiving a connection request transmission control protocol (TCP) packet from a TCP client of the terminal;
transmitting the connection request TCP packet to a base station;
creating an initial PDCP TCP context to perform at least part of a TCP procedure in advance;
transmitting the initial PDCP TCP context to the base station;
receiving a connection permission TCP packet from a TCP server through the base station;
delivering the connection permission TCP packet to the TCP client;
receiving a response to the initial PDCP TCP context from the base station; and
in response to receiving a connection establishment TCP packet from the TCP client, discarding the received connection establishment TCP packet.

13. The terminal according to claim 12, wherein the at least one processor further causes the terminal to perform: obtaining information on a size of a reception buffer of the TCP server included in the connection permission TCP packet.

14. The terminal according to claim 12, wherein the at least one processor further causes the terminal to perform:
receiving, from the TCP client, data TCP packet(s) including data to be transmitted to the TCP server;
obtaining information on a size of the data included in the data TCP packet(s);
transmitting the data TCP packet(s) to the base station;
generating an acknowledgment TCP packet corresponding to the data TCP packet(s) transmitted to the base station; and
transmitting the acknowledgment TCP packet to the TCP client.

15. The terminal according to claim 14, wherein the acknowledgment TCP packet is generated based on at least one of capability information of the terminal, information on a size of a reception buffer of the TCP server, or the information on the size of the data included in the data TCP packet(s).

16. The terminal according to claim 12, wherein the at least one processor further causes the terminal to perform:
receiving a connection termination TCP packet from the TCP client;
transmitting the connection termination TCP packet to the base station;
in response to receiving the connection termination TCP packet, transmitting, to the base station, a first PDCP message including PDCP TCP context deletion preparation request information; and
receiving, from the base station, a second PDCP message including information indicating that a PDCP TCP context of the base station is ready to be deleted.

17. The terminal according to claim 16, wherein the at least one processor further causes the terminal to perform:
in response to receiving an acknowledgment TCP packet for TCP connection termination from the TCP client, transmitting the acknowledgment TCP packet to the base station;
in response to transmitting the acknowledgment TCP packet for TCP connection termination, transmitting, the base station, a third PDCP TCP message requesting deletion of the PDCP TCP context; and
deleting the PDCP TCP context.
